(19) United States
(12) Patent Application Publication
(10) Pub. No.: US 2013/0325744 A1
(43) Pub. Date: Dec. 5, 2013

(54) INTERACTIVE BUSINESS DATA DISPLAYS FOR EMPLOYEES

(71) Applicants: Eyal Sinai, Kfar Saba (IL); Volker Guzman, Heidelberg (DE); Guy Kirschbaum, Ra'anana (IL); Lior Schejter, Binyamina (IL)

(72) Inventors: Eyal Sinai, Kfar Saba (IL); Volker Guzman, Heidelberg (DE); Guy Kirschbaum, Ra'anana (IL); Lior Schejter, Binyamina (IL)

(21) Appl. No.: 13/483,479

(22) Filed: May 30, 2012

(51) Int. Cl. G06Q 99/00

(52) U.S. Cl. 705/345

(57) ABSTRACT

According to some embodiments, an employee identifier may be received from an employee of an enterprise via an employee device. Based on the employee identifier, a subset of customers associated with the employee may be determined, and business data for each customer in the subset of customers may be received from a remote business server. For each customer in the subset of customers, a display of a virtual plant on the employee device may be automatically facilitated, wherein the display of each plant is automatically modified based at least in part on the business data received for that customer. According to some embodiments, an interactive employee input associated with a first virtual plant is received via the employee device and the display of the first virtual plant may be further modified based on the interactive employee input.

### FIELD

Some embodiments relate to systems and methods associated with business data. More specifically, some embodiments are directed to systems and methods to provide interactive business data displays for employees of an enterprise.

### BACKGROUND

A business enterprise may want employees to receive, and in some cases respond to, business data. For example, an enterprise might want salespeople to be aware of how many products have been sold during the current fiscal quarter (e.g., to help the salespeople meet a sales goal). Similarly, an enterprise might want an information technology employees to be aware of a number of complaints that have been received in connection with a web-based service (e.g., so the employees can correct problems with the service). Generally, business data is presented to employees as a table of numbers, a graph, or a pie chart. Such presentations, however, can make the information difficult to understand, and many employees may become bored and disinterested in the information. As result, the employees may maintain awareness of the business data (e.g., and might not meet a sales quota).

Accordingly, methods and mechanisms to efficiently, accurately, and automatically display business data to employees in an engaging manner may be provided in accordance with some embodiments described herein.

### BRIEF DESCRIPTION OF THE DRAWINGS

FIG. 1 illustrates a business data display that might be provided to an employee.

FIG. 2 is a block diagram of a system to support the display of business data to employees according to some embodiments.

FIG. 3 is a flow diagram of a process in accordance with some embodiments.

FIG. 4 illustrates a business data display in accordance with some embodiments.

FIG. 5 illustrates potential modifications to a business data display in accordance with some embodiments.

FIG. 6 illustrates a potential user interaction with a business data display in accordance with some embodiments.

FIG. 7 illustrates a business data display in accordance with other embodiments.

FIG. 8 illustrates a business data display in accordance with still other embodiments.

FIG. 9 is a block diagram of an apparatus according to some embodiments.

FIG. 10 illustrates a portion of a tabular database that might be stored in accordance with some embodiments.

### DETAILED DESCRIPTION

A business enterprise may want employees to receive, and in some cases respond to, business data. For example, an enterprise might want salespeople to be aware of how many products have been sold during the current fiscal quarter (e.g., to help the salespeople meet a sales goal). Similarly, an enterprise might want an information technology employees to be aware of a number of complaints that have been received in connection with a web-based service (e.g., so the employees can correct problems with the service).

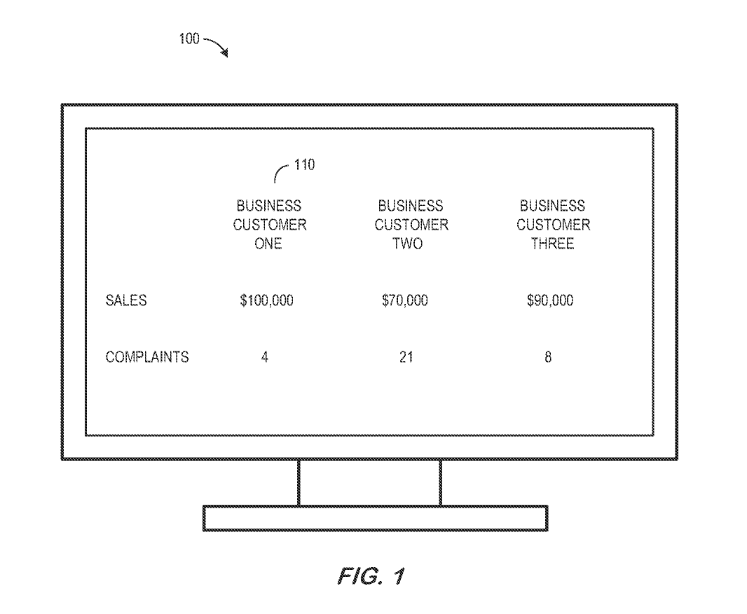

Generally, business data is presented to employees as a table of numbers, a graph, or a pie chart. For example, FIG. 1 illustrates a business data display 100 that might be provided to an employee of an enterprise. The display 100 includes “sales” and “complaints” information for a number of different business customers 110 of the enterprise (e.g., the sales value for business customer two is $70,000). Such a presentation, however, can make the information difficult to understand, and many employees may become bored and disinterested in the information. As result, the employees may maintain awareness of the business data (e.g., and might not meet a sales quota).

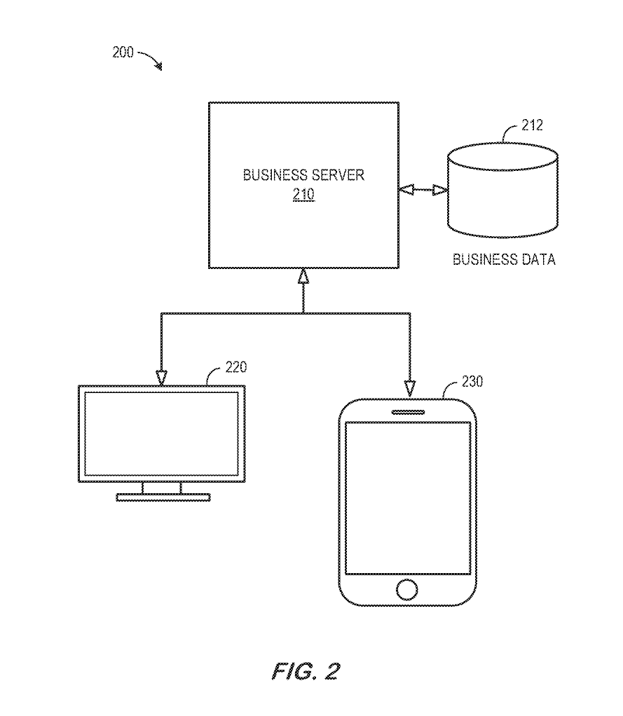

Accordingly, methods and mechanisms to efficiently, accurately, and automatically display business data to employees in an engaging manner may be provided in accordance with some embodiments described herein. For example, FIG. 2 is a block diagram 200 of a system according to some embodiments. The system 200 includes a business server 210 coupled to one or more databases or data stores containing business data 212. By way of example only, the business server 210 might be associated with an Enterprise Resource Planning (ERP) server, a business services gateway, a HyperText Transfer Protocol (HTTP) server, and/or an Advanced Business Application Programming (ABAP) server.

According to some embodiments, the business server 210 may directly communicate with one or more remote employee devices 220, 230 via the Internet. According to other embodiments, a gateway may be provided between the business server 210 and the employee devices 220, 230. The employee devices 220, 230 may include one or more processors to receive business data and/or to execute applications and/or components (e.g., a plug-in that is integrated to a smartphone).

Note that FIG. 2 represents a logical architecture for the system 200 according to some embodiments, and actual implementations may include more or different components arranged in other manners. Moreover, each system described herein may be implemented by any number of devices in communication via any number of other public and/or private networks. Two or more of devices may be located remote from one another and may communicate with one another via any known manner of network(s) and/or a dedicated connection. Further, each device may comprise any number of hardware and/or software elements suitable to provide the functions described herein as well as any other functions. Other topologies may be used in conjunction with other embodiments.

Any of the devices illustrated in FIG. 2, including the business server 210 and employee devices 220, 230 may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

All systems and processes discussed herein may be embodied in program code stored on one or more computer-readable media. Such media may include, for example, a floppy disk, a CD-ROM, a DVD-ROM, magnetic tape, OR solid state Random Access Memory (RAM) or Read Only Memory (ROM) storage units. Embodiments are therefore not limited to any specific combination of hardware and software.

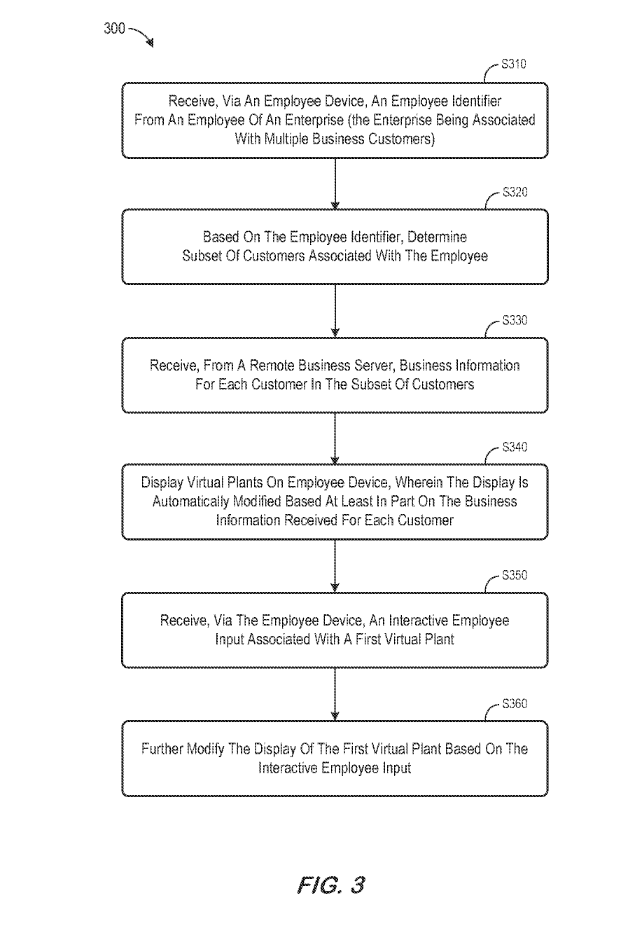

FIG. 3 is a flow diagram of a process 300 that might be associated with the business server 210 and/or employee devices 220, 230 of FIG. 2 according to some embodiments. Note that all processes described herein may be executed by any combination of hardware and/or software. The processes may be embodied in program code stored on a tangible medium and executable by a computer to provide the functions described herein. Further note that the flow charts described herein do not imply a fixed order to the steps, and embodiments of the present invention may be practiced in any order that is practicable.

At S310, an employee identifier may be received from an employee of an enterprise via an employee device. The enterprise may be, for example, associated with a plurality of business “customers.” The customers may be customers of the enterprise, represent various geographic locations, and/or comprise sub-portions of the enterprise. According to some embodiments, the employee device may associated with, for example, a Personal Computer (PC), a mobile computer, a smartphone, a gaming device, a television device, a projector, an eyeglass display, a table with a built-in display, a three-dimensional display, and/or any other appropriate device or set of devices. The employee identifier might be associated with, for example, a user name and/or password.

At S320, a subset of customers associated with the employee may be determined based on the employee identifier. For example, an enterprise might have five hundred business customers, but a particular employee might only be responsible for three of those customers.

At S330, business data for each customer in the subset of customers may be received from a remote business server. The received business data might be associated with for example: (i) sales information, (ii) customer satisfaction, (iii) customer complaints, (iv) profit information, or (v) social network information.

At S340, for each customer in the subset of customers, a display of a “virtual plant” may be provided on the employee device. As used herein, the phrase “virtual plant” might refer to a two or three dimensional representation of: (i) a flowing plant, (ii) a fruit plant, (iii) a vegetable plant, (iv) a mushroom, (v) a vine, or (vi) a tree. Moreover, according to some embodiments, the display of each plant is “automatically” modified based at least in part on the business data received for that customer. As used herein, the term “automatically” may refer to an operation or process performed with little or no human intervention. Note that the modification of the virtual plant might be associated with, for example: (i) a plant size, (ii) a plant height, (iii) a plant color, (iv) flowers, (v) fruits, (vi) vegetables, (vii) leaves, (viii) roots, or (ix) a face.

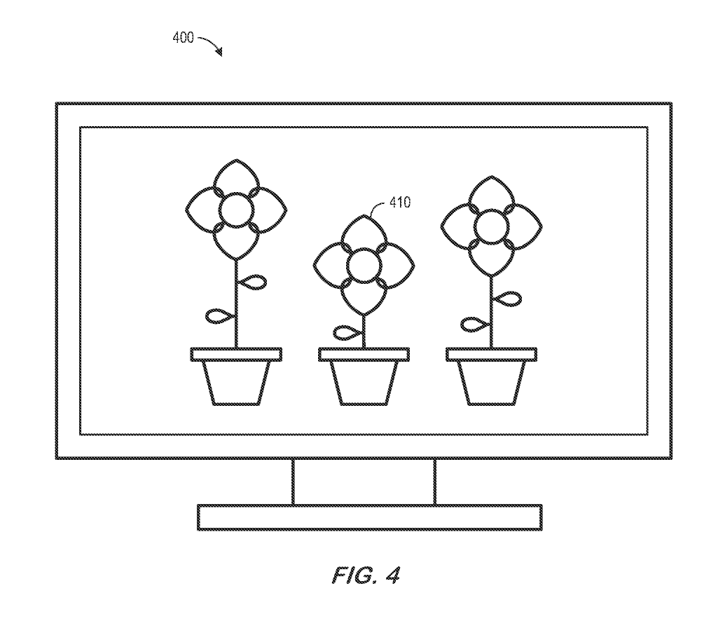

For example, FIG. 4 illustrates a business data display 400 including three virtual plants 410 (each associated with a different business customer) that could be provided on an employee device in accordance with some embodiments. Note that a plant 410 associated with one customer having high sales might be displayed as bright green (e.g., healthy) while another plant 410 associated with another customer having low sales might be displayed as dark brown (e.g., sickly). Note that such a garden of virtual plants 410 may engage an employee and bring out his or her natural nurturing instincts (e.g., he or she will naturally want to make the garden appear more healthy).

At S350, an interactive employee input associated with a first virtual plant may be received via the employee device. The interactive employee input may be associated with, for example: (i) a mouse button activation, or (ii) a touch screen input. For example, an employee might use a mouse button to click on one of the virtual plants 410 provided on the display 400 of FIG. 4. At S360, the display of the first virtual plant may be further modified based on the interactive employee input. According to some embodiments, the virtual plants are associated with a game goal and the employee's ability to achieve the game goal is adjusted based at least in part on the received business data. As used herein, a game “goal” might be associated with, for example, a score, a grade, and/or a game achievement or trophy. Moreover, a “game” might refer to any type of interactive, entertaining, and engaging activity including a role playing game, a race, a tower defense game, a puzzle, or a word game. According to some embodiments, an interaction between an employee and a virtual plant may be directly connected to a business activity (or set of possible activities). For example, watering a plant might result in the mailing of a catalog to the associated client. In this way, an interaction in a game may imply a business process or step initiated by the “playing” employee.

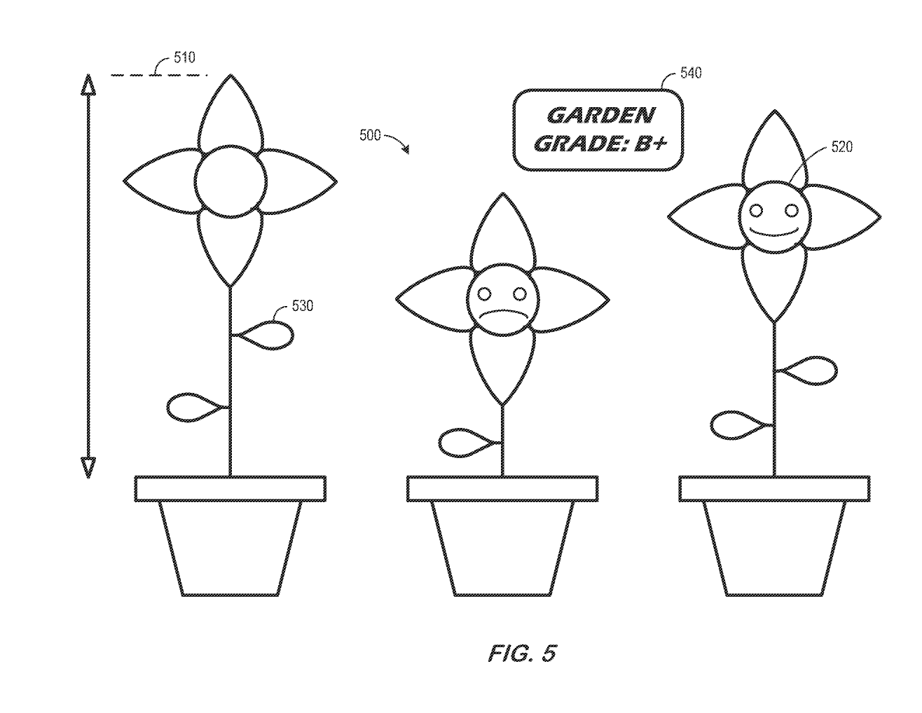

FIG. 5 illustrates potential modifications to a business data display 500 in accordance with some embodiments. In this example, the height 510 of each plant is adjusted based on sales data. As a result, the left most virtual plan is taller as compared to the middle virtual plant (e.g., because the company represented by the leftmost virtual plant had sales of $100,00 while the company represented by the middle virtual plant had sales of only $70,000). As another example, anthropomorphism might be used to display a happy face 520 (or sad face) in connection with a virtual plant. In same cases, a number of leaves 530 or roots associated with a virtual plant might be based on business data (e.g., and an employee might attempt to grow three leaves 530 on each plant to receive a game bonus). As still another example, a game score or grade 540 might be automatically determined and provided on the employee device display 500.

A user may interact with one or more of the virtual plants. For example,

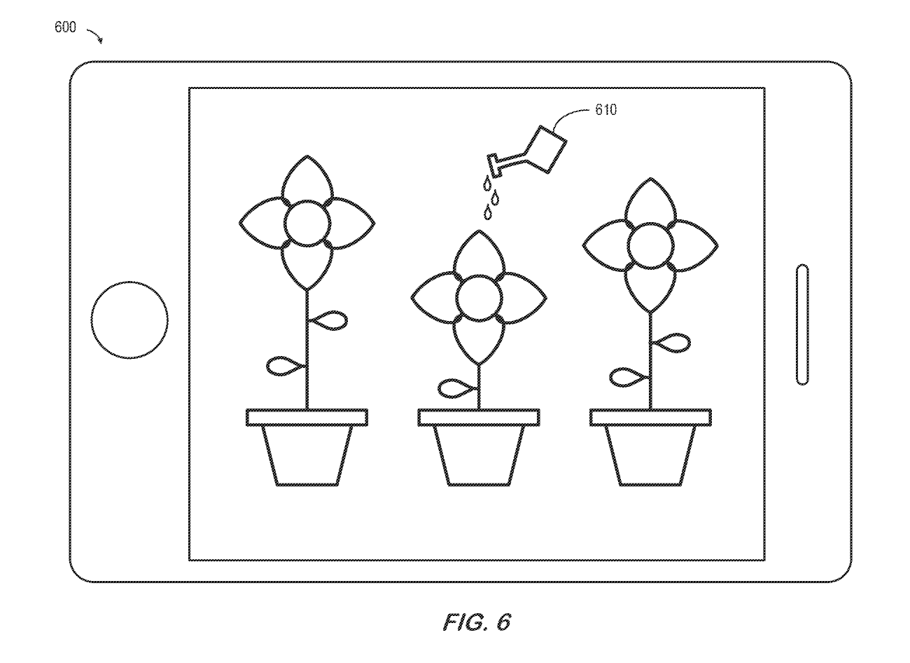

FIG. 6 illustrates a potential user interaction with a business data display 600 in accordance with some embodiments. In the display 600, the interactive employee input is associated with providing nourishment to one of the virtual plants in the form of water from a watering can 610 (e.g., the employee might use his or her finger to slide the watering can 610 over a virtual plant an then tap the watering can 610 to shake the water drops out). As other examples, an employee might provide nourishment in the form of sunlight, fresh air, seeds, and/or fertilizer that are given to the virtual plants. As still other examples, an employee might weed or trim a garden of virtual plants. Note that any of these activities might help engage the employee with the business data and help him or her pay attention to the information over relatively long periods of time (as compared to a table of numbers or a traditional graph).

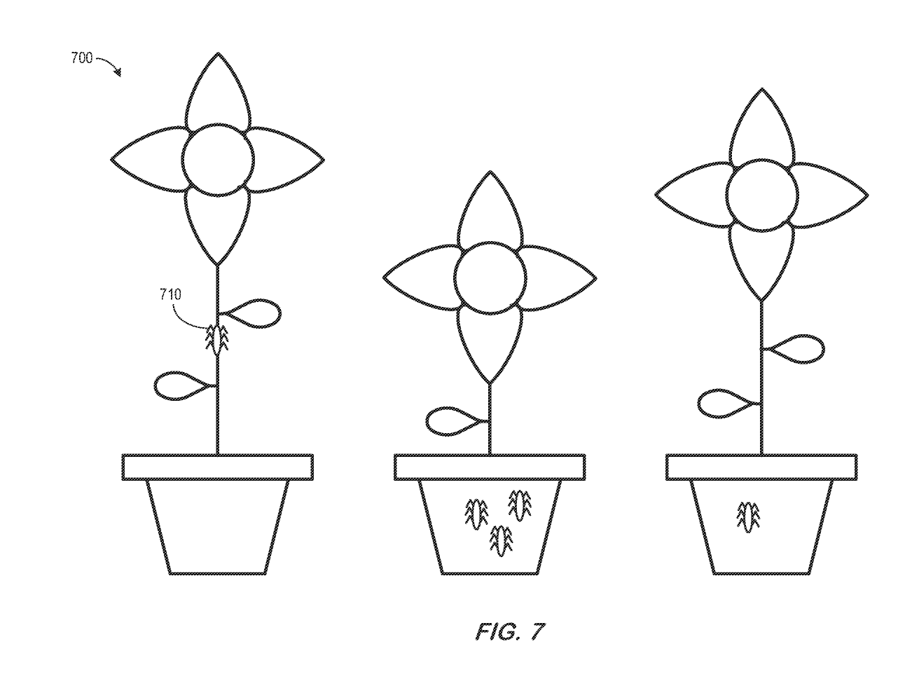

In addition to nourishing virtual plants, an employee might be encouraged to protect the plants to further engage him or her with the business data. For example, FIG. 7 illustrates a business data display 700 in accordance with other embodiments. In this case, the received business data includes negative information about the first customer, such as a number of claims that have been received from the customer. According to some embodiments, a display of a threat to the virtual plant on the employee device display 700 might be provided in the form of insects 710 (including, for example, bugs, caterpillars, worms, mold, or any other type of threat to the virtual plant). In same cases, the location or movement of insects 710 might be associated with a severity of the negative information. In this example, an interactive employee input might be associated with removing the insects 710 from one of the virtual plants (e.g., he or she might need to click on moving insects 710 to remove them one-by-one from the display to improve his or her game score).

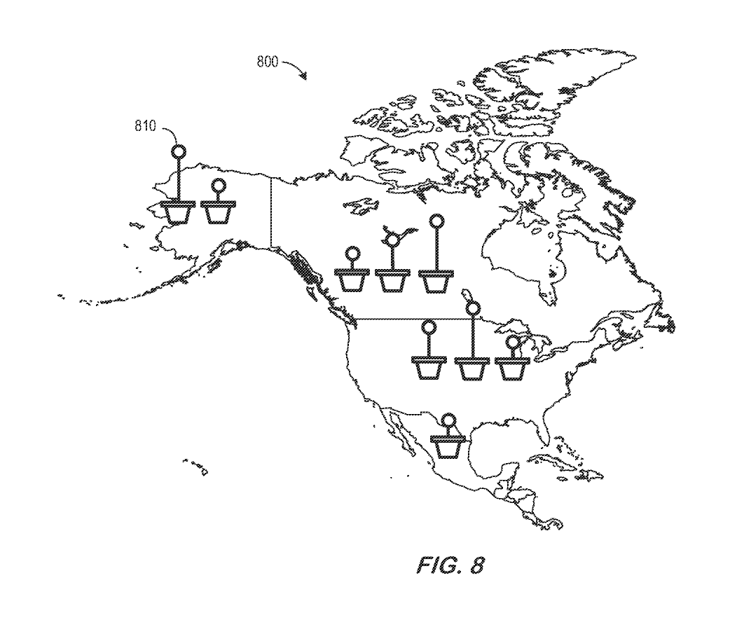

According to some embodiments, more than one virtual garden might be displayed to an employee. For example, FIG. 8 illustrates a business data display 800 wherein different employees and/or customers are associated with different geographic locations. In this case, one or more gardens 810 of virtual plants may be displayed on a map in accordance with the geographic locations. According to some embodiments, gardens 810 and/or virtual plants associated with a plurality of employees are simultaneously provided via the display 800 on the employee device (e.g., gardens 810 associated with various enterprise teams around the world might be provided on the display 800).

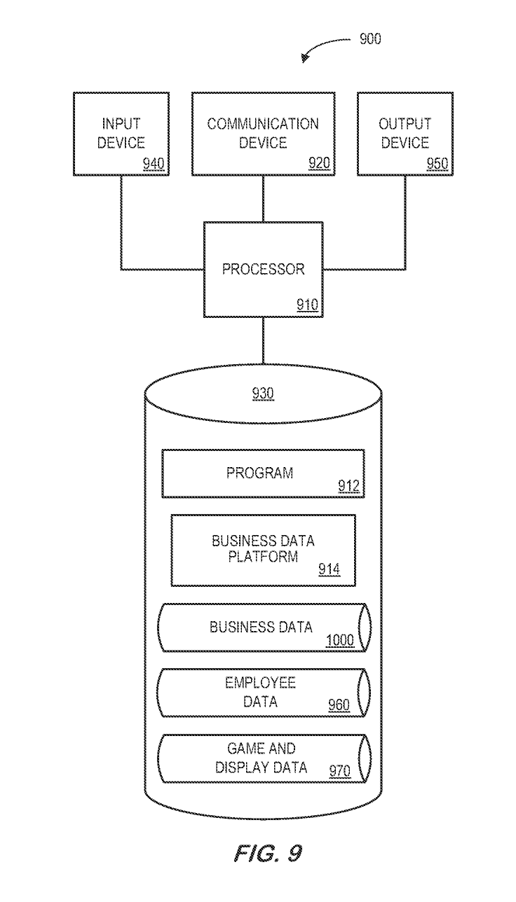

Note that the architecture described with respect to FIG. 2 is provided only as an example, and any other type of apparatus might be provided instead. For example FIG. 9 is a block diagram overview of one such apparatus 900 according to some embodiments. The apparatus 900 may be, for example, associated with an employee device and/or a business server. The apparatus 900 comprises a processor 910, such as one or more commercially available Central Processing Units (CPUs) in the form of one-chip microprocessors, coupled to a communication device 920 configured to communicate via a communication network (not shown in FIG. 9). The communication device 920 may be used, for example, as an input path to receive employee inputs and/or business system data. The apparatus 900 further includes an input device 940 (e.g., a mouse and/or keyboard to enter configuration, messaging, and/or business activity information) and an output device 950 (e.g., a computer monitor to display business information reports and/or game data).

The processor 910 communicates with a storage device 930. The storage device 930 may comprise any appropriate information storage device, including combinations of magnetic storage devices (e.g., a hard disk drive), optical storage devices, and/or semiconductor memory devices. The storage device 930 stores a program 912 and/or business data platform 914 for controlling the processor 910. The processor 910 performs instructions of the programs 912, 914, and thereby operates in accordance with any of the embodiments described herein. For example, the processor 910 may receive an employee identifier from an employee of an enterprise. The enterprise may be, for example, associated with a plurality of business customers. Based on the employee identifier, a subset of customers associated with the employee may be determined by the processor 910, and business data for each customer in the subset of customers may be received from a remote business server. For each customer in the subset of customers, a display of a virtual plant may be automatically facilitated by the processor 910, wherein the display of each plant is automatically modified by the processor 910 based at least in part on the business data received for that customer. According to some embodiments, an interactive employee input associated with a first virtual plant is received by the processor 910 and the display of the first virtual plant may be further modified based on the interactive employee input.

The programs 912, 914 may be stored in a compressed, uncompiled and/or encrypted format. The programs 912, 914 may furthermore include other program elements, such as an operating system, a database management system, and/or device drivers used by the processor 910 to interface with peripheral devices.

As used herein, information may be “received” by or “transmitted” to, for example: (i) the apparatus 900 from another device; or (ii) a software application or module within the apparatus 900 from another software application, module, or any other source.

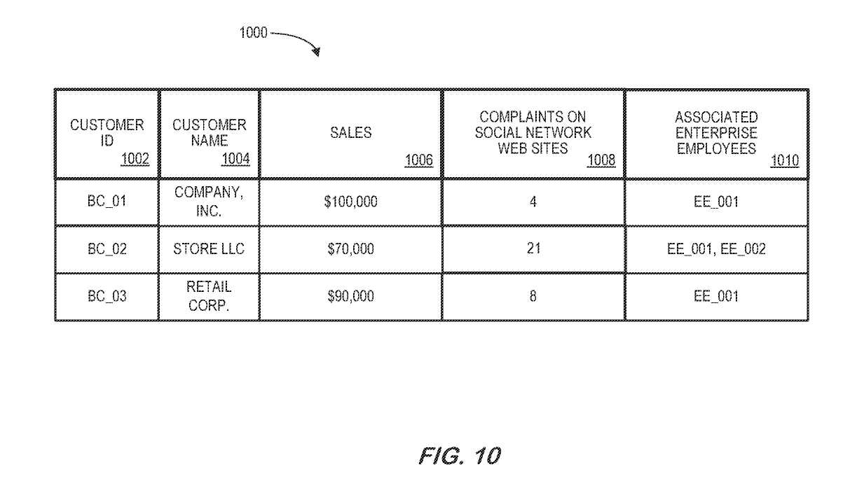

In some embodiments (such as shown in FIG. 9), the storage device 930 stores a business data database 100, employee data database 960 (e.g., including employee user names and passwords), and/or game and display data database 970 (e.g., high scores and game achievements). An example of a business data database 1000 that may be used in connection with the apparatus 900 will now be described in detail with respect to FIG. 10. Note that the database described herein is only an example, and additional and/or different information may be stored therein. Moreover, various databases might be split or combined in accordance with any of the embodiments described herein.

Referring to FIG. 10, a table is shown that represents the business data database 1000 that may be stored at the apparatus 900 according to some embodiments. The table may include, for example, entries identifying business customers who are associated with an enterprise. The table may also define fields 1002, 1004, 1006, 1008, 1010 for each of the entries. The fields 1002, 1004, 1006, 1008, 1010 may, according to some embodiments, specify: a customer identifier 1002, a customer name 1004, sales 1006, complaints on social network web sites 1008, and associated enterprise employees 1010. The information in the business data database 1000 may be created and updated, for example, based on data received from an ERP system or other source of business information.

The customer identifier 1002 may be, for example, a unique alphanumeric code identifying a customer of the enterprise, and the customer name 1004 may represent the name of that customer. The sales 1006 might represent a value of products or services that have been provided to the customer (e.g., during the current year). The complaints on social network web sites 1008 might, for example, be automatically counted based on Facebook posts, Twitter posts, YouTube comments, etc. The associated enterprise employees 1010 might comprise, for example, identifiers associated with employees who need to receive business data in connection with that particular customer. In the example of FIG. 10, employee “EE_{—}001” might be provided with virtual plants associated with customer identifiers “BA_{—}01,” “BC_{—}02,” and “BC_{—}03” while employee “EE_{—}002” would only be provided with a virtual plant for customer identifier “BC_{—}02.”

Thus, some embodiments may establish methods and mechanisms to efficiently, accurately, and automatically display business data to employees in an engaging manner. Moreover, embodiments may let naturally encourage employees to improve the real-world activities that drive the business data (e.g., to reduce a number of complaints received by an enterprise).

The following illustrates various additional embodiments and do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although embodiments have been described with respect to business systems, note that embodiments may be associated with other types of enterprise data. For example, financial, governmental, and/or medical information may be processed in accordance with any of the embodiments described herein.

Moreover, while embodiments have been illustrated using particular types of games and displays, embodiments may be implemented in any other of a number of different ways. For example, some embodiments might be associated with a farming simulation where improved business data results in better equipment to be used on the farm (e.g., tractors or irrigation systems) and/or improved weather conditions for the crops.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer implemented method, comprising:
receiving, via an employee device, an employee identifier from an employee of an enterprise, wherein the enterprise is associated with a plurality of business customers;
based on the employee identifier, determining a subset of customers associated with the employee;
receiving, from a remote business server, business data for each customer in the subset of customers;
for each customer in the subset of customers, automatically facilitating by a processor a display of a virtual plant on the employee device, wherein the display of each plant is automatically modified by the processor based at least in part on the business data received for that customer;
receiving, via the employee device, an interactive employee input associated with a first virtual plant; and
further modifying the display of the first virtual plant based on the interactive employee input.

2. The method of claim 1, wherein the employee device is associated with at least one of: (i) a personal computer, (ii) a mobile computer, (iii) a smartphone, (iv) a gaming device, or (v) a television device.

3. The method of claim 1, wherein the remote business server is associated with at least one of: (i) an enterprise resource planning server, (ii) a business services gateway, (iii) a hypertext transfer protocol server, or (iv) an Advanced Business Application Programming server.

4. The method of claim 3, wherein the received business data is associated with at least one of: (i) sales information, (ii) customer satisfaction, (iii) customer complaints, (iv) profit information, or (v) social network information.

5. The method of claim 1, wherein the virtual plant is associated with at least one of: (i) a flowing plant, (ii) a fruit plant, (iii) a vegetable plant, (iv) a mushroom, (v) a vine, or (vi) a tree.

6. The method of claim 1, wherein the modification of the virtual plant is associated with at least one of: (i) a plant size, (ii) a plant height, (iii) a plant color, (iv) flowers, (v) fruits, (vi) vegetables, (vii) leaves, (viii) roots, or (ix) a face.

7. The method of claim 1, wherein the received business data includes negative information about the first customer and further comprising:
automatically facilitating by the processor a display of a threat to the virtual plant on the employee device.

8. The method of claim 1, wherein the interactive employee input is associated with at least one of: (i) a mouse button activation, or (ii) a touch screen input.

9. The method of claim 8, wherein the interactive employee input is associated with: (i) providing nourishment to one of the virtual plants, (ii) removing a threat from one of the virtual plants.

10. The method of claim 1, wherein the virtual plants are associated with a game goal and the interactive employee input initiates a business process step.

11. The method of claim 10, wherein the employee's ability to achieve the game goal is adjusted based at least in part on the received business data.

12. The method of claim 1, wherein each customer is associated with a geographic location and said virtual plants are displayed on a map in accordance with the geographic locations.

13. The method of claim 1, wherein virtual plants associated with a plurality of employees are displayed on the employee device.

14. A non-transitory, computer-readable medium storing program code executable by a computer processor to perform a method, the method comprising:
receiving, via an employee device, an employee identifier from an employee of an enterprise, wherein the enterprise is associated with a plurality of business customers;
based on the employee identifier, determining a subset of customers associated with the employee;
receiving, from a remote business server, business data for each customer in the subset of customers;
for each customer in the subset of customers, automatically facilitating by a processor a display of a virtual plant on the employee device, wherein the display of each plant is automatically modified by the processor based at least in part on the business data received for that customer;
receiving, via the employee device, an interactive employee input associated with a first virtual plant; and
further modifying the display of the first virtual plant based on the interactive employee input.

15. The method of claim 14, wherein the employee device is associated with at least one of: (i) a personal computer, (ii) a mobile computer, (iii) a smartphone, (iv) a gaming device, or (v) a television device.

16. The method of claim 14, wherein the remote business server is associated with at least one of: (i) an enterprise resource planning server, (ii) a business services gateway, (iii) a hypertext transfer protocol server, or (iv) an Advanced Business Application Programming server.

17. The method of claim 16, wherein the received business data is associated with at least one of: (i) sales information, (ii) customer satisfaction, (iii) customer complaints, (iv) profit information, or (v) social network information.

18. A system, comprising:
a business server to transmit device information for each customer in a set of customers associated with an employee identifier;
an employee device, remote from the business server to: (i) receive the employee identifier from an employee, (ii) receive the business data, (iii) for each customer in the set of customers, display a virtual plant, wherein the display of each plant is automatically modified by the processor based at least in part on the business data received for that customer, (iv) receive an interactive employee input associated with a first virtual plant, and (v) further modify the display of the first virtual plant based on the interactive employee input.

19. The system of claim 18, wherein the business server is associated with at least one of: (i) an enterprise resource planning server, (ii) a business services gateway, (iii) a hypertext transfer protocol server, or (iv) an Advanced Business Application Programming server.

20. The system of claim 19, wherein the business data is associated with at least one of: (i) sales information, (ii) customer satisfaction, (iii) customer complaints, (iv) profit information, or (v) social network information.
